(19) United States
(12) Patent Application Publication
(10) Pub. No.: US 2026/0112006 A1
(43) Pub. Date: Apr. 23, 2026

(54) CAMERA PERSPECTIVE CORRECTION FOR FRAME COMPOSITION

(71) Applicant: Cisco Technology, Inc., San Jose, CA (US)

(72) Inventors: Mattias AHNOFF, Fornebu (NO); Torbjørn KRINGELAND, Spikkestad (NO)

(21) Appl. No.: 18/919,669

(22) Filed: Oct. 18, 2024

(51) Int. Cl. G06T 5/80; G06T 3/60; G06T 5/50; G06T 7/11; G06T 7/30

(52) U.S. Cl. CPC G06T 5/80; G06T 3/60; G06T 5/50; G06T 7/11; G06T 7/30; G06T 2207/10016; G06T 2207/20021; G06T 2207/20132; G06T 2207/30196

(57) ABSTRACT

In one embodiment, a method can include obtaining, by a processing device, an image captured by an imaging device, the image including a plurality of subjects in a particular environment. The method can further include separating, by the processing device, the image into a plurality of frames, wherein each frame of the plurality of frames includes one or more particular subjects among the plurality of subjects and performing, by the processing device, an operation to re-orient a particular frame of the plurality of frames to generate at least one re-oriented frame, wherein the at least one re-oriented frame is oriented along a particular vertical edge of the particular frame. The method can further include providing, by the processing device, the at least one re-oriented frame for display on a display device.

### TECHNICAL FIELD

The present disclosure relates generally to computer networks, and, more particularly, to camera perspective correction for frame correction.

### BACKGROUND

In general, images captured from imaging devices, such as cameras, webcams, videoconferencing cameras, etc. can exhibit a keystone effect due to the angle at which the imaging device is oriented during capture of the images. For example, in a videoconferencing setting where multiple participants at one location may be sitting around a conference table at different distances and angles from an imaging device, the keystone effect may manifest itself in the form of the participants appearing to observers to lean inward or outward from the center of the field of the imaging device.

Currently, some approaches ignore the keystone effect and simply provide a video stream of a videoconference as is with no correction to the images that make up the video stream. In some scenarios this may be perfectly acceptable. However, some approaches seek to mitigate the keystone effect by rotating images (e.g., digital crops) of the video stream so that the center of each image (e.g., a line bisecting the image) is aligned vertically.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example full view captured by an imaging device with the perspective corrected crop positions indicated;

FIG. 4 illustrates an example where the individual frames are aligned at their respective midpoints which causes an inward leaning effect;

FIG. 5 illustrates an example where the individual frames are aligned at their respective edges;

FIG. 6 illustrates another example full view captured by an imaging device with the perspective corrected crop positions indicated;

FIG. 7 illustrates an example where an individual frame at aligned at its respective edge;

FIG. 8 illustrates yet another example full view captured by an imaging device with the perspective corrected crop positions indicated;

FIG. 9 illustrates another example where the individual frames are aligned at their respective edges; and

FIG. 10 illustrates an example procedure for camera perspective correction for frame correction.

### DESCRIPTION OF EXAMPLE EMBODIMENTS

### Overview

According to one or more embodiments of the disclosure, a method can include obtaining, by a processing device, an image captured by an imaging device, the image including a plurality of subjects in a particular environment. The method can further include separating, by the processing device, the image into a plurality of frames, wherein each frame of the plurality of frames includes one or more particular subjects among the plurality of subjects, and performing, by the processing device, an operation to re-orient a particular frame of the plurality of frames to generate at least one re-oriented frame, wherein the at least one re-oriented frame is oriented along a particular vertical edge of the particular frame. The method can further include providing, by the processing device, the at least one re-oriented frame for display on a display device.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

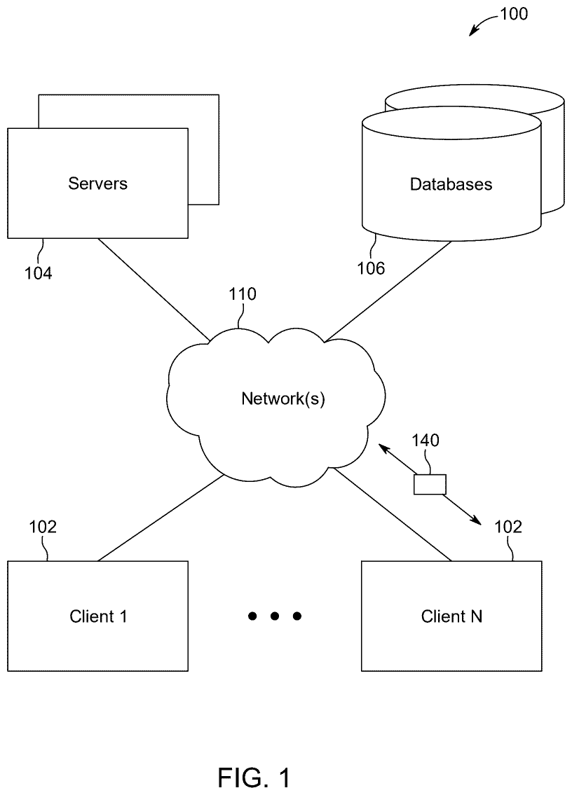

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

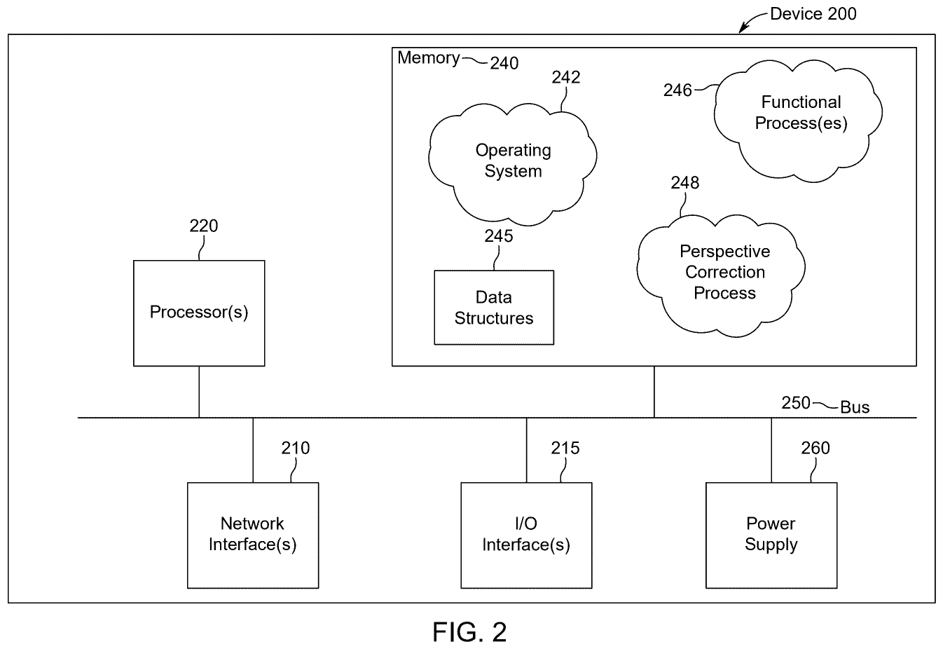

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a perspective correction process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, an imaging device can be configured to capture video and/or images, a computing system can be configured to provide a videoconferencing environment, and so on.

In various implementations, as detailed further below, one or more functional processes 246 and/or perspective correction process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as video streams and/or images) and recognize complex patterns in these data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Notably, for web-based conferencing services, such as a videoconference, teleconference, one-on-one (e.g., VoIP) calls, and so on, the one or more functional processes 246 may be configured to allow device 200 to participate in a virtual meeting/conference during which, for example, audio data captured by audio interfaces and optionally video data captured by video interfaces is exchanged with other participating devices of the virtual meeting (or a videoconference) via network interfaces 210. In addition, conferencing processes may provide audio data and/or video data captured by other participating devices to a user via audio interfaces and/or video interfaces, respectively. As would be appreciated, such an exchange of audio and/or video data may be facilitated by a web conferencing service (e.g., Webex by Cisco Systems, Inc., etc.) that may be hosted in a data center, the cloud, or the like.

For instance, an example meeting room may have a collaboration endpoint, according to various embodiments, where during operation, the collaboration endpoint may capture video via its one or more cameras, audio via one or more microphones, and provide the captured audio and video to any number of remote locations (e.g., other collaboration endpoints) via a network. Such videoconferencing may be achieved via a videoconferencing/management service located in a particular data center or the cloud, which serves to broker connectivity between the collaboration endpoint and the other endpoints for a given meeting. For instance, the service may mix audio captured from different endpoints, video captured from different endpoints, etc., into a finalized set of audio and video data for presentation to the participants of a virtual meeting (or a videoconference). Accordingly, the collaboration endpoint may also include a display and/or speakers, to present such data to any virtual meeting (or a videoconference) participants located in the meeting room.

Also, a control display may also be installed in the meeting room that allows a user to provide control commands for the collaboration endpoint. For instance, a control display may be a touch screen display that allows a user to start a virtual meeting, make configuration changes for the videoconference or a collaboration endpoint (e.g., enabling or disabling a mute option, adjusting the volume, etc.).

In some cases, any of the functionalities of a collaboration endpoint, such as capturing audio and video for a virtual meeting (or a videoconference), communicating with a videoconferencing service, presenting videoconference data to a virtual meeting participant, etc., may be performed by other devices, as well. For instance, a personal device such as a laptop computer, desktop computer, mobile phone, tablet, or the like, may be configured to function as an endpoint for a videoconference (e.g., through execution of a videoconferencing client application), in a manner similar to that of a collaboration endpoint.

### Camera Perspective Correction for Frame Correction

As noted above, images captured from imaging devices, such as cameras, webcams, videoconferencing cameras, etc. can exhibit a keystone effect due to the angle at which the imaging device is oriented during capture of the images. For example, image crops (or individual frames) from the sides of a video conference camera that is pointing slightly down during a videoconference will generally exhibit the keystone effect.

In some approaches, camera digital crops may be adjusted so that the center of the crop is perfectly vertical (i.e., the crop is aligned such that a line that bisects the crop is perfectly vertical). That is, if the camera is physically tilted down, such as in a conference room with a large display at one end of the room, digital crops of participants located to the sides of the conference room can be rotated to compensate for the keystone effect, and this compensation is aligned to the center of each individual crop.

Although this approach generally works well in some applications, it might not work as well in applications that utilize a composition of several individual crops (e.g., crops focusing on different people that are taken from different areas in an environment, such as a conference room). That is, even though individual people can be framed in individual crops in applications that utilize a composition of several individual crops, there might be an impression that they belong together in an environment (e.g., a meeting room, conference room, etc.) that spans across the boundaries of the individual crops. This can in turn result in the appearance that the individual people are leaning towards the center of the composition.

Further, some approaches may generate compositions using individual crops that are rectangular crops, without any rotation or perspective correction, and stitch these crops side by side in a composed image. However, this can result in people to the sides of the original image appearing stretched out because of the perspective, and if the camera is mounted with an angle downwards, people to the side can also appear to be leaning outwards.

The techniques herein therefore provide methodologies for aligning individual crops in hybrid meeting applications to cause the overall composition of a composed image to have a more correct geometry. More specifically, implementations described herein can align the individual crops (also referred to herein as “frames”) along an edge of the frames as opposed to the center of each individual frame. As discussed in more detail herein, this can correct the keystone effect by which people can appear to be leaning outward or inward thereby providing a more natural appearance to the composition.

In some implementations, a perspective-corrected crop can be used to correct these and other perspective related effects to provide a more natural appearance to the composition. A perspective-corrected crop can be a crop taken from an overview image (e.g., an image of all participants in a conference room) that is then warped in a way so that it looks as if the camera were pointed toward the participant (as opposed to at an angle with respect to the participant). If the crop is off-center, a perspective-corrected crop will map to a kite-shaped box in the overview picture, as discussed in more detail, herein. That is, a crop that is rectangular after perspective correction has been applied has had some other shape before perspective correction is applied.

In addition to, or in the alternative, “roll compensation” techniques can be used to approximate perspective correction. In general, however, roll compensation is a simplified correction that may only adjust for the rotational perspective effect. Accordingly, implementations discussed herein are generally performed using perspective correction but may include roll compensation techniques as well.

As discussed in more detail herein, a simplified process in accordance with the disclosure can include:
Capturing an image (e.g., an overview picture) of a room (e.g., a conference room) in which participants are arranged.
From this overview picture, multiple crops can be taken and put into an output picture (e.g. the frames composition).
The selection of crops and their relative positions are somewhat inconsequential’ however, by way of example if there is a big meeting room with twelve participants, the system might have decided that four of the participants should be shown in a frames composition. These participants can appear in the same left-to-right order as in the meeting room, but in theory they could all be from one side of the table. Thus, it is not given that the persons in the middle of the composition are sitting in the middle of the room.
From here, the frames composition process can include performing a copy-paste type operation from the input picture to an output picture, as opposed to a manipulation of the input picture. For example, crops can be copied from the input image, perspective corrected, and then pasted into a “frame” in the output picture in accordance with the disclosure.

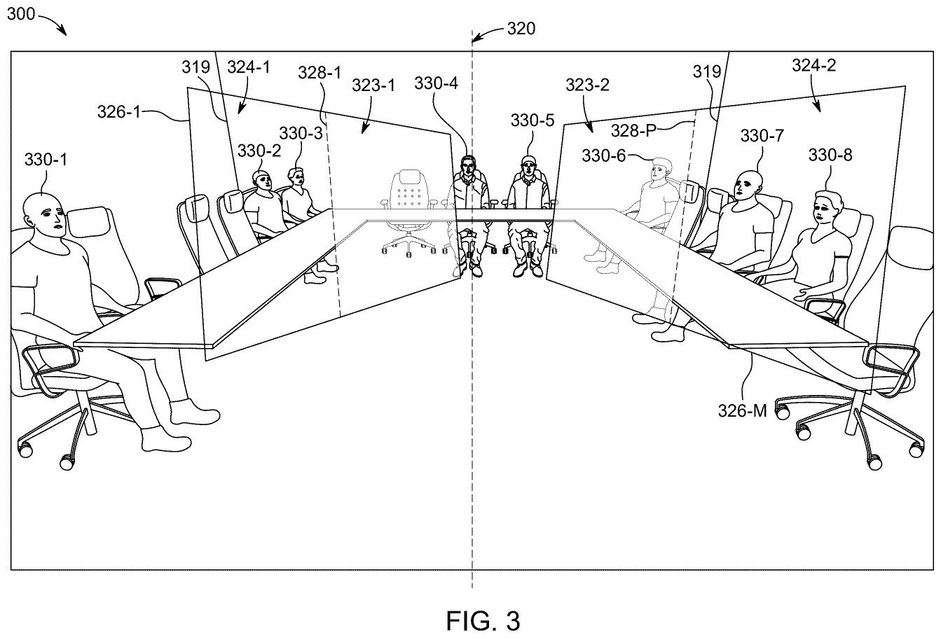

Multiple techniques for camera perspective correction for frame correction are contemplated within the scope of the disclosure. For illustration purposes, a first technique is generally discussed herein. The first technique can, as described in more detail below, take perspective-corrected crops having an aspect ratio that is the same as the full frames composition (e.g., 16:9 in the example of FIG. 3, et seq.), but only use the part of the crop that corresponds to the location of the crop in the composed image. That is, a portion of the perspective-corrected crops having an aspect ratio that is the same as the full frames composition can be disregarded, leaving a portion of the crop that includes one or more participants.

A second technique disclosed herein involves taking crops having aspect ratios that match the aspect ratio of the individual frames in the frames composition and rotating these crops so that their borders match. For example, crops having an 8:9 aspect ratio can be taken and then aligned along vertical edges of the crops. It will be appreciated that the aspect ratios mentioned herein are merely for illustration purposes and crops having other aspect ratios can be used without departing from the scope of the disclosure.

Specifically, according to one or more embodiments of the disclosure as described in detail below, a method can include obtaining, by a processing device, an image captured by an imaging device, the image including a plurality of subjects in a particular environment. The method can further include separating, by the processing device, the image into a plurality of frames, wherein each frame of the plurality of frames includes one or more particular subjects among the plurality of subjects, and performing, by the processing device, an operation to re-orient a particular frame of the plurality of frames to generate at least one re-oriented frame, wherein the at least one re-oriented frame is oriented along a particular vertical edge of the particular frame. The method can further include providing, by the processing device, the at least one re-oriented frame for display on a display device.

Operationally, FIG. 3 illustrates an example full view of an image 300 captured by an imaging device with the perspective corrected crop positions indicated. The image 300 shown in FIG. 3 can be a particular frame captured by the imaging device when the imaging device is operating to capture a video stream of, for example, a videoconference. In some implementations, the image 300 can have a center 320 that bisects the image 300. It is noted that the center line 320 is generally associated with the output compositions described herein as opposed to being associated with the input overview picture (e.g., an image of the entire videoconference prior to the perspective correction operations described herein.

In the example of FIG. 3, the image 300 can be captured by a webcam that is mounted on a display device that is located at one end of a conference room. It is however noted that the example of FIG. 3 is merely provided to elucidate implementations of the disclosure and is not intended to be limiting to the scope of the disclosure. Accordingly, other scenarios, imaging devices, environments, and the like are contemplated within the scope of the disclosure.

Returning to the example of FIG. 3, when composing a composition from a meeting room with an imaging device (e.g., a camera, webcam, 360° imaging device, etc.) mounted above a display device (so that the imaging device tilted down), and the perspective correction is performed so that each individual crop (or frame) is “correctly” perspective corrected, it can produce a perception of the whole composition leaning inwards. This can be due to the composition being perceived as being from the same room due to the furniture, back walls, lighting, etc., as well as the keystone effect mentioned above. However, in such a composition, the human brain may expect an outward leaning perspective as opposed to the straightened perspective that is the result of a composition of frames that have been individually corrected without taking the context into account.

Further, due to perspective effects introduced by the placement of the imaging device, lines 319 associated with walls/corners of the room can appear to be angled, as shown in FIG. 3.

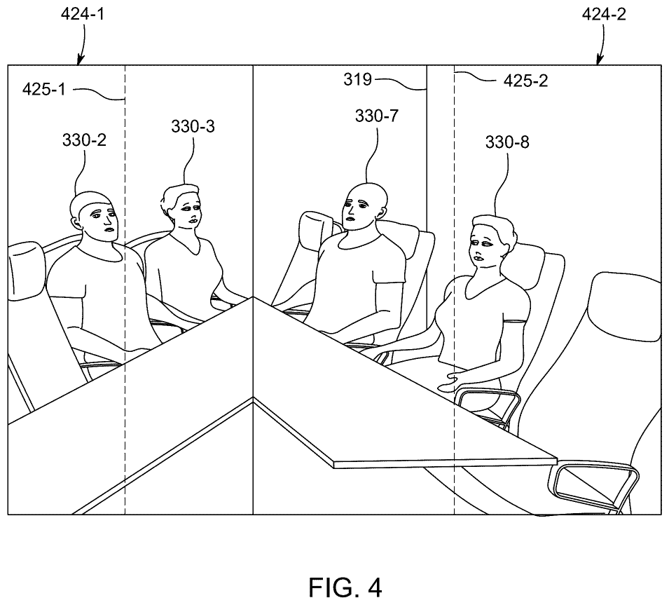

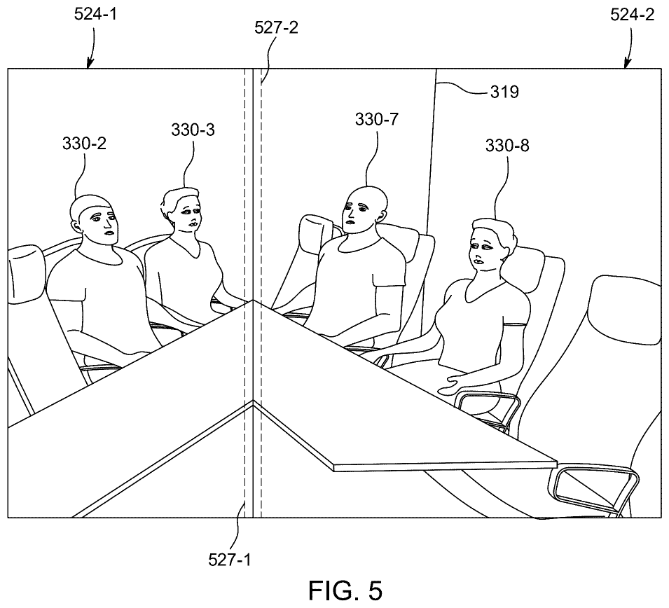

In order to remedy this issue, implementations herein allow for composing a composition of multiple (e.g., two, three, four, etc.) images from the same by performing perspective correction that is aligned at the boundaries of individual frames (e.g., at the first vertical edge 527-1 and the second vertical edge 527-2 shown in FIG. 5 below) as opposed to the center of the individual frames (e.g., at the first center line 425-1 and the second center line 425-2 shown in FIG. 4 below).

Turning back the example of FIG. 3, where the image 300 includes a plurality of participants (e.g., a first participant 330-1, a second participant 330-2, a third participant 330-3, a fourth participant 330-4, a fifth participant 330-5, a sixth participant 330-6, a seventh participant 330-7, and an eighth participant 330-8) seated at different locations in an environment (e.g., a conference room), it can be possible to capture particular participants in different crops and then perform the operations described herein to correct the perspective for such participants.

One way to achieve this can be to take a first 8:9 crop 324-1 and a second 8:9 crop 323-1 to capture the second participant 330-2 and the third participant 330-3 and then treat the first 8:9 crop 324-1 and the second 8:9 crop 323-1 as a first 16:9 crop 326-1. As shown in FIG. 3, the center of the first 16:9 crop 326-1 (e.g., the center line 328-1) can be treated as an edge (e.g., the first vertical edge 527-1 of FIG. 5) for purposes of “rolling” the crop for perspective correction. Similarly, it is possible to take a third 8:9 crop 323-2 and a fourth 8:9 crop 324-2 to capture the seventh participant 330-7 and the eighth participant 330-8 and then treat the third 8:9 crop 323-2 and the fourth 8:9 crop 324-2 as a second 16:9 crop 326-M. As shown in FIG. 3, the center of the second 16:9 crop 326-M (e.g., the center line 328-P) can be treated as an edge (e.g., the second vertical edge 527-2 of FIG. 5) for purposes of performing perspective correction.

As used herein, “perspective correction” generally refers to a process taking a crop from the source image and “warping” the crop so that the result is the same as if a physical camera had been pointed in the direction of crop. This is illustrated in FIG. 3 and FIG. 5 where in FIG. 3, the first 16:9 crop 326-1 and the second 16:9 crop 326-M appear to be “kite-shaped” quadrilaterals in the input image, but subsequent to performance of perspective correction have been “warped” into a rectangle shape (e.g., the first crop 524-1 and the second crop 524-2 illustrated in FIG. 5).

FIG. 4 illustrates an example where the individual frames are aligned at their respective midpoints which causes an inward leaning effect. In the example of FIG. 4, a first crop 424-1 (which can be analogous to the first 8:9 crop 324-1 of FIG. 3) has been aligned along a first center line 425-1 (e.g., a line that bisects the first crop 424-1) and a second crop 424-2 (which can be analogous to the fourth 8:9 crop 324-2 of FIG. 3) has been aligned along a second center line 425-2 (e.g., a line that bisects the second crop 424-2). That is, as shown in FIG. 4, the first center line 425-1 and the second center line 425-2 can be aligned with a line 319 associated with a wall/corner of the room.

It is noted that the example of FIG. 4 depicts methodologies employed by some current approaches and, as a result, exhibits the “inward leaning” effect discussed above. That is, in the example of FIG. 4, a viewer can perceive that the composition is from the same meeting room (because of furniture, walls, how people sit, etc.) and with this perception, the composition can look incorrect as it appears that the lean inwards in the composition.

FIG. 5 illustrates an example architecture where the individual frames are aligned at their respective edges. In the example of FIG. 5, a first crop 524-1 (which can be analogous to the first 8:9 crop 324-1 of FIG. 3 and/or the first crop 424-1 of FIG. 4) has been aligned along a first vertical edge 527-1 and a second crop 524-2 (which can be analogous to the fourth 8:9 crop 324-2 of FIG. 3 and/or the second crop 424-2 of FIG. 4) has been aligned along a second vertical edge 527-2. As seen in FIG. 5, the “inward leaning” effect discussed above and illustrated in FIG. 4 has been remediated and the participants appear to a viewer to be sitting upright as opposed to leaning inward toward the center where the first crop 524-1 and the second crop 524-2 meet. In this example, the first vertical edge 527-1 and the second vertical edge 527-2 are aligned, however, they may not be aligned with the line 319 associated with a wall/corner of the room.

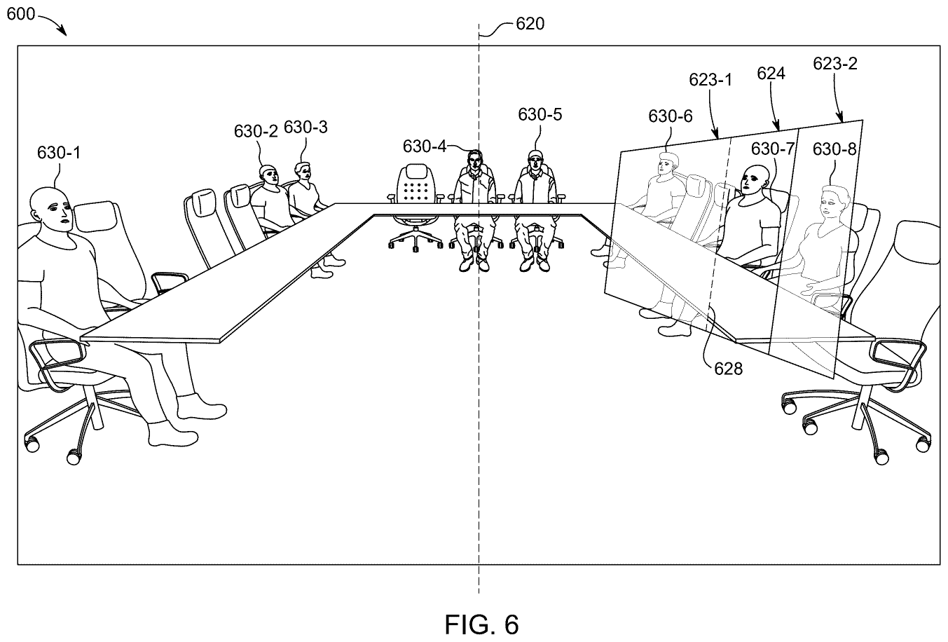

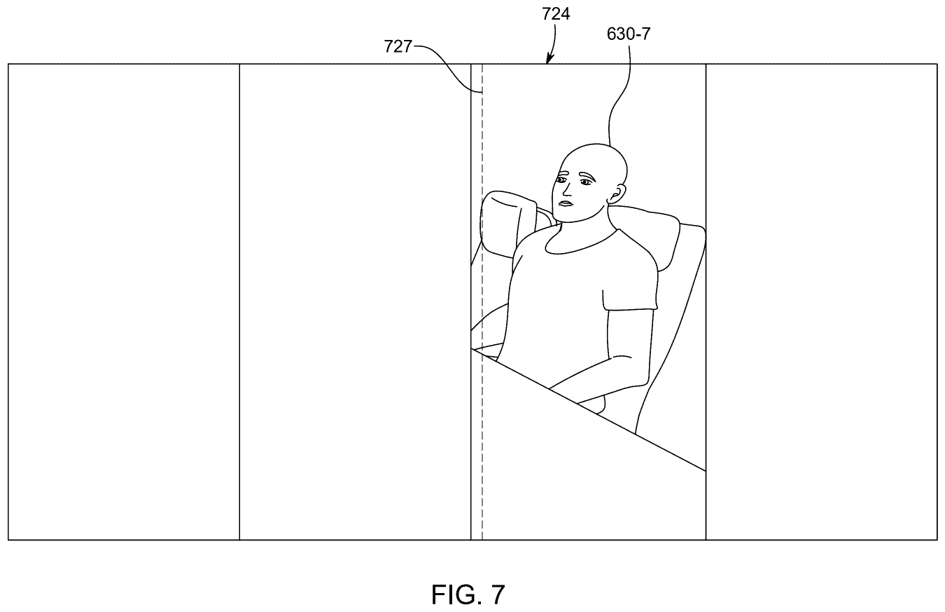

As mentioned above, the foregoing non-limiting example uses a case where two frames are corrected. However, implementations are not so limited, and the same techniques can be extended and applied to three frames, four frames, or other multi-frame scenarios, as discussed in more detail below in connection with FIG. 6 and FIG. 7.

FIG. 6 illustrates another example full view image captured by an imaging device with the perspective corrected crop positions indicated. The image 600 shown in FIG. 6 can be a particular frame captured by the imaging device when the imaging device is operating to capture a video stream of, for example, a videoconference. In some implementations, the image 600 can have a center 620 that bisects the image 600.

As shown in FIG. 6, the image 600 includes a plurality of participants (e.g., a first participant 630-1, a second participant 630-2, a third participant 630-3, a fourth participant 630-4, a fifth participant 630-5, a sixth participant 630-6, a seventh participant 630-7, and an eight participant 630-8) seated at different locations in an environment (e.g., a conference room), and it can be possible to capture particular participants in different crops and then perform the operations described herein to correct the perspective for such participants.

For example, to provide correction for the third position from the left in a four-frame composition, the target frame position (e.g., the seventh participant 630-7 in this example) is located in a narrow tile 624 (e.g., a crop having a 4:9 aspect ratio). In this example, perspective correction can be applied as if the crop were in a 16:9 aspect ratio (i.e., the crop includes not only the narrow tile 624, but also a first crop 623-1 and a second crop 623-2) and then crop out the narrow tile 624 leaving the frame having the target participant.

Similar to the examples above, in this example, the center of the 16:9 crop (e.g., the center line 628) can be treated as an edge (e.g., the vertical edge 727 of FIG. 7) for purposes of “rolling” the crop for perspective correction.

FIG. 7 illustrates an example where an individual frame at aligned at its respective edge. In the example of FIG. 7, a crop (e.g., the narrow tile 724, which can be analogous to the narrow tile 624 of FIG. 6) has been aligned along a vertical edge 727. As seen in FIG. 7, the “inward leaning” effect discussed above and illustrated in FIG. 4 has been remediated and the participant appears to a viewer to be sitting upright as opposed to leaning inward toward the center of the image 600 illustrated above in FIG. 6.

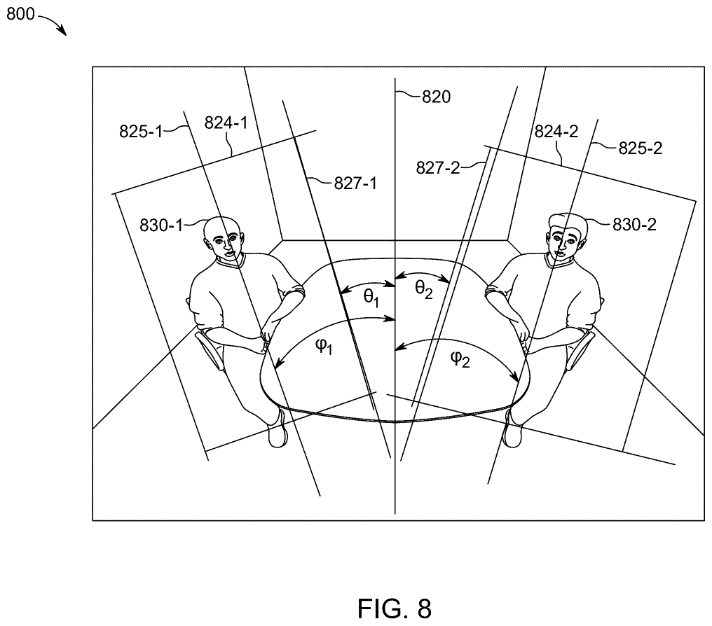

FIG. 8 illustrates yet another example full view image captured by an imaging device with the perspective corrected crop positions indicated. The image 800 shown in FIG. 8 can be a particular frame captured by the imaging device when the imaging device is operating to capture a video stream of, for example, a videoconference. In some implementations, the image 800 can have a center line 820 that bisects the image 800.

As shown in FIG. 8, the image 800 includes a plurality of participants (e.g., a first participant 830-1 and a second participant 830-2 seated at different locations in an environment (e.g., a conference room). In the example of FIG. 8, a first crop 824-1 (which can be analogous to the first 8:9 crop 324-1 of FIG. 3, the first crop 424-1 of FIG. 4, and/or the first crop 524-1 of FIG. 5) and a second crop 824-2 (which can be analogous to the fourth 8:9 crop 324-2 of FIG. 3, the second crop 424-2 of FIG. 4, and/or the second crop 524-2 of FIG. 5) can be captured by the imaging device.

As discussed above, each of these crops (e.g., the first crop 824-1 and the second crop 824-2) can have a center line that bisects the respective crops, such as a first center line 825-1 that bisects the first crop 824-1 and a second center line 825-2 that bisects the second crop 824-2. In addition, each of the crops can have an edge, such as a first vertical edge 827-1 associated with the first crop 824-1 and a second vertical edge 827-2 associated with the second crop 824-2.

In some approaches, it is customary to align the first center line 825-1 such that it is parallel to the center line 820 and to align the second center line 825-2 such that it is also parallel to the center line 820. It is noted that the center line 820 is generally associated with the output composition as opposed to being associated with the input overview picture described herein. That is, in some approaches, the first crop 824-1 can be rotated by the angle φ₁ to align the first center line 825-1 with the center line 820 and the second crop 824-2 can be rotated by the angle φ₂ to align the second center line 825-2 with the center line 820. However, as discussed above, this can create an effect in which the first participant 830-1 and the second participant 830-2 appear to be leaning inward toward the center line 820 from the perspective of a viewer.

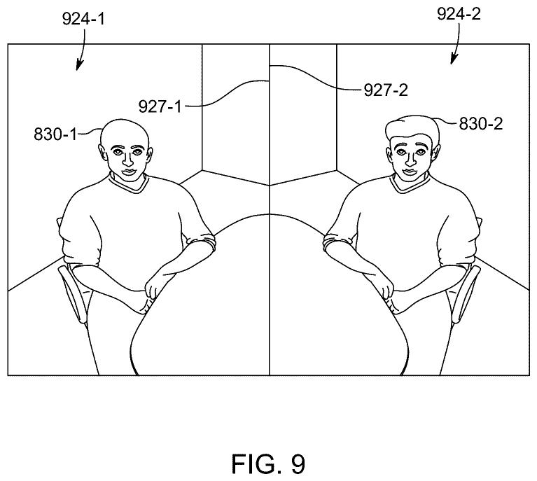

In order to remedy this behavior, implementations herein can align the first vertical edge 827-1 associated with the first crop 824-1 such that it is parallel to the center line 820 and to align the second vertical edge 827-2 associated with the second crop 824-2 such that it is also parallel to the center line 820. That is, in some approaches, the first crop 824-1 can be rotated by the angle θ₁ to align the first center line 825-1 with the center line 820 and the second crop 824-2 can be rotated by the angle θ₂ to align the second center line 825-2 with the center line 820. The result is shown in FIG. 9, where the first participant 830-1 and the second participant 830-2 appear to be sitting up and do not appear to be leaning inward toward the center of the image.

An alternate way to state the above is that, at the outset, an overview image of the whole room with the participants is captured. As discussed above, the image need not be a “static” image, as in some implementations the image is more accurately envisioned as a series of images captured as part of a video taken, for example during a videoconferencing meeting from a webcam or similar image capture device.

From this image, multiple crops may be taken (e.g., the first crop 824-1 and the second crop 824-2) and put into an output picture (e.g., a frames composition). If there is a big meeting room with twelve participants, the system might have decided that four of the participants are to be shown in a frames composition. In general, these four participants that are selected for the frames composition can appear in the same left-to-right order as in the meeting room, but in theory they could all be seated on one side of the table. Thus, it is not given that the persons in the middle of the composition are sitting in the middle of the room.

In such implementations, the frames composition process can be viewed as a copy-paste type operation from the input picture to an output picture, as opposed to a manipulation of the input picture. That is, in some implementations, crops can be copied from the input image, perspective corrected, and then pasted into a “frame” in the output picture as discussed herein.

FIG. 9 illustrates another example where the individual frames are aligned at their respective edges. In the example of FIG. 9, a first crop 924-1 (which can be analogous to the first 8:9 crop 324-1 of FIG. 3, the first crop 424-1 of FIG. 4, the first crop 524-1 of FIG. 5, and/or the first crop 824-1 of FIG. 8) has been aligned along a first vertical edge 927-1 and a second crop 924-2 (which can be analogous to the fourth 8:9 crop 324-2 of FIG. 3, the second crop 424-2 of FIG. 4, and/or the second crop 824-2 of FIG. 8) has been aligned along a second vertical edge 927-2. As seen in FIG. 5, the “inward leaning” effect discussed above and illustrated in FIG. 8 (and above) has been remediated and the participants appear to a viewer to be sitting upright as opposed to leaning inward toward the center where the first crop 924-1 and the second crop 924-2 meet. Although the lines representing the corner of the room in the background of FIG. 9 appear to be vertical, implementations are not to so limited and, in some scenarios these lines may appear to be angled slightly outward or slightly inward from the edges of the crops in order to provide the perspective correction disclosed herein.

In addition to aligning the perspective and/or roll of the crops discussed above, some implementations provide for alignment in a horizontal direction with respect to the crops. For example, in some implementations, the crops can further be aligned in a horizontal direction (either with respect to a horizontal edge of the crop(s) or with respect to a horizontal bisection line, or with respect to any line that may be drawn through the crop(s) along a horizontal axis of such crop(s). This can allow for the head heights to mimic how they are positioned in an environment, such as a conference room, among other possibilities.

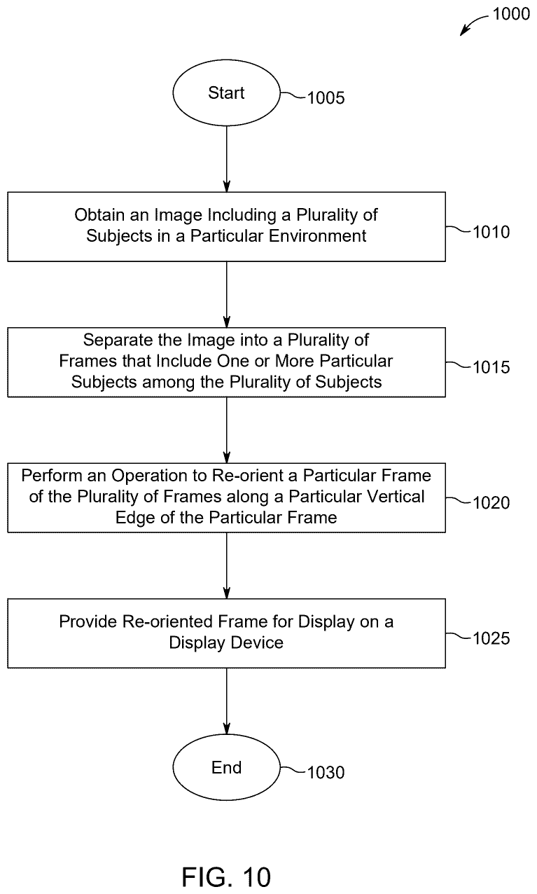

In closing, FIG. 10 illustrates an example simplified procedure for camera perspective correction for frame correction in accordance with one or more embodiments described herein. For example, a non-generic, specifically configured device (e.g., device 200, an apparatus) may perform procedure 1000 by executing stored instructions (e.g., process 248). The procedure 1000 may start at step 1005, and continues to step 1010, where, as described in greater detail above, a processing device obtains an image captured by an imaging device, the image including a plurality of subjects in a particular environment. In some implementations, the imaging device can be a camera operating in a video conference environment and the image can be captured from a video stream captured by the imaging device.

The procedure 1000 may continue to step 1015 where, as discussed above, the processing device separates the image into a plurality of frames. In some implementations each frame of the plurality of frames can include one or more particular subjects among the plurality of subjects.

The procedure 1000 may continue to step 1020 where, as discussed above, the processing device performs an operation to re-orient a particular frame of the plurality of frames to generate at least one re-oriented frame. In some implementations, the at least one re-oriented frame is oriented along a particular vertical edge of the particular frame. As discussed above, the image may have a center and the particular vertical edge can be a vertical edge of the particular frame closest to the center. In addition to, or in the alternative, in some implementations, the at least one re-oriented frame can be further re-oriented horizontally.

In various implementations, the procedure 1000 can further include removing, by the processing device, at least a portion of the image as part of performing the operation to re-orient the particular frame. Further, as discussed above, in some implementations, the procedure 1000 can include performing the operation to re-orient the particular frame to correct a visual perspective of at least one of the plurality of subjects that is to be displayed by a display device.

The procedure 1000 may continue to step 1025 where, as discussed above, the processing device provides the at least one re-oriented frame for display on a display device. In some implementations, the procedure 1000 can include providing the at least one re-oriented frame for display on the display device in real time.

In some implementations, a first re-oriented frame of the at least one re-oriented frame includes a first single subject, a second re-oriented frame of the at least one re-oriented frame includes a second single subject, and the first single subject and the second single subject are located at different locations within a conference room having a central location with respect to a field of view associated with the imaging device. In such implementations, the procedure 1000 can further include re-orienting the first re-oriented frame along a vertical edge of the at least one re-oriented frame includes the first single subject that is closest to the central location of the conference room and re-orienting the second re-oriented frame along a vertical edge of the at least one re-oriented frame includes the second single subject that is closest to the central location of the conference room.

Implementations are not so limited, however, and in some implementations, a third re-oriented frame of the at least one re-oriented frame includes a third single subject, and the third single subject is located within the conference room. In such implementations, the procedure 1000 can further include re-orienting the third re-oriented frame along a vertical edge of the at least one re-oriented frame includes the third single subject that is closest to the central location of the conference room. In addition to, or in the alternative, in some implementations, the procedure 1000 can further include re-orienting the third re-oriented frame along a vertical edge of the at least one re-oriented frame that is parallel to a vertical edge of the first re-oriented frame or a vertical edge of the second re-oriented frame. That is, in some implementations, a vertical edge of the third re-oriented frame can be caused to be parallel with the vertical edge of the first re-oriented frame and/or the second re-oriented frame.

Although implementations directly above have been discussed in terms of a single subject (e.g., the first single subject, second single subject, third single subject, etc.), it will be appreciated that one or more of the re-oriented frames can include multiple subjects. For example, the first re-oriented frame can include a single subject, the second re-oriented frame can include two subjects, and the third re-oriented frame can include two subjects, and so on and so forth. It will further be appreciated that this example is non-limiting and other combinations of quantities of subjects in one or more of the re-oriented frames are contemplated within the scope of the disclosure.

As discussed above, in some implementations, the procedure 1000 can include altering, by the processing device, an aspect ratio of the image as part of providing the at least one re-oriented frame for display on the display device. For example, the 16:9 images discussed above can be cropped to frames that have an 8:9 aspect ratio, a 4:9 aspect ratio, and so on and so forth. Implementations are not so limited, however, and in some implementations, the procedure 100 can include generating, by the processing device, a perspective corrected crop of a particular aspect ratio of the image as part of generating the at least one re-oriented frame. For example, the 16:9 images discussed above can be cropped to an 8:9 aspect ratio, etc.

Procedure 1000 may end at step 1030.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: obtaining, by a processing device, an image captured by an imaging device, the image including a plurality of subjects in a particular environment; separating, by the processing device, the image into a plurality of frames, wherein each frame of the plurality of frames includes one or more particular subjects among the plurality of subjects; performing, by the processing device, an operation to re-orient a particular frame of the plurality of frames to generate at least one re-oriented frame, wherein the at least one re-oriented frame is oriented along a particular vertical edge of the particular frame; and providing, by the processing device, the at least one re-oriented frame for display on a display device.

In still other implementations, a tangible, non-transitory, computer-readable medium storing program instructions that cause a device to execute a process comprising: obtaining, by a processing device, an image captured by an imaging device, the image including a plurality of subjects in a particular environment; separating, by the processing device, the image into a plurality of frames, wherein each frame of the plurality of frames includes one or more particular subjects among the plurality of subjects; performing, by the processing device, an operation to re-orient a particular frame of the plurality of frames to generate at least one re-oriented frame, wherein the at least one re-oriented frame is oriented along a particular vertical edge of the particular frame; and providing, by the processing device, the at least one re-oriented frame for display on a display device.

The techniques described herein, therefore, provide for camera perspective correction for frame correction. More specifically, the techniques herein provide methodologies for aligning individual crops in hybrid meeting applications to cause the overall composition of a composed image to have a more correct geometry. As discussed above, implementations described herein can align the individual crops (also referred to herein as “frames”) along an edge of the frames as opposed to the center of each individual frame. This can correct the keystone effect by which people can appear to be leaning outward or inward thereby providing a more natural appearance to the composition and provide a more natural user experience for participants in hybrid meetings.

Illustratively, the techniques described herein may be performed by hardware, software, and/or firmware, (e.g., an “apparatus”) such as in accordance with the perspective correction process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
obtaining, by a processing device, an image captured by an imaging device, the image including a plurality of subjects in a particular environment;
separating, by the processing device, the image into a plurality of frames, wherein each frame of the plurality of frames includes one or more particular subjects among the plurality of subjects;
performing, by the processing device, an operation to re-orient a particular frame of the plurality of frames to generate at least one re-oriented frame, wherein the at least one re-oriented frame is oriented along a particular vertical edge of the particular frame; and
providing, by the processing device, the at least one re-oriented frame for display on a display device.

2. The method of claim 1, further comprising:
providing the at least one re-oriented frame for display on the display device in real time.

3. The method of claim 1, wherein the image has a center, and wherein the particular vertical edge is a vertical edge of the particular frame closest to the center.

4. The method of claim 1, wherein the at least one re-oriented frame is further re-oriented horizontally.

5. The method of claim 1, further comprising:
a first re-oriented frame of the at least one re-oriented frame includes a first single subject,
a second re-oriented frame of the at least one re-oriented frame includes a second single subject, and
the first single subject and the second single subject are located at different locations within a conference room having a central location with respect to a field of view associated with the imaging device, and the method further comprises:
re-orienting the first re-oriented frame along a vertical edge of the at least one re-oriented frame includes the first single subject that is closest to the central location of the conference room; and
re-orienting the second re-oriented frame along a vertical edge of the at least one re-oriented frame includes the second single subject that is closest to the central location of the conference room.

6. The method of claim 5, wherein:
a third re-oriented frame of the at least one re-oriented frame includes a third single subject, and
the third single subject is located within the conference room, and the method further comprises:
re-orienting the third re-oriented frame along a vertical edge of the at least one re-oriented frame that is parallel to a vertical edge of the first re-oriented frame or a vertical edge of the second re-oriented frame.

7. The method of claim 1, further comprising:
generating, by the processing device, a perspective corrected crop of a particular aspect ratio of the image as part of generating the at least one re-oriented frame.

8. The method of claim 1, further comprising:
removing, by the processing device, at least a portion of the image as part of performing the operation to re-orient the particular frame.

9. The method of claim 1, wherein:
the imaging device comprises a camera operating in a video conference environment, and
the image is captured from a video stream captured by the imaging device.

10. The method of claim 1, further comprising:
performing the operation to re-orient the particular frame to correct a visual perspective of at least one of the plurality of subjects that is to be displayed by the display device.

11. An apparatus, comprising:
one or more network interfaces to communicate with a network;
a processor coupled to the one or more network interfaces and configured to execute one or more processes; and
a memory configured to store a process that is executable by the processor, the process comprising:
obtaining an image captured by an imaging device, the image including a plurality of subjects in a particular environment;
separating the image into a plurality of frames, wherein each frame of the plurality of frames includes one or more particular subjects among the plurality of subjects;
performing an operation to re-orient a particular frame of the plurality of frames to generate at least one re-oriented frame, wherein the at least one re-oriented frame is oriented along a particular vertical edge of the particular frame; and
providing the at least one re-oriented frame for display on a display device.

12. The apparatus of claim 11, the process further comprising:
providing the at least one re-oriented frame for display on the display device in real time.

13. The apparatus of claim 11, wherein the image has a center, and wherein the particular vertical edge is a vertical edge of the particular frame closest to the center.

14. The apparatus of claim 11, wherein the at least one re-oriented frame is further re-oriented horizontally.

15. The apparatus of claim 11, wherein:
a first re-oriented frame of the at least one re-oriented frame includes a first single subject,
a second re-oriented frame of the at least one re-oriented frame includes a second single subject, and
the first single subject and the second single subject are located at different locations within a conference room having a central location with respect to a field of view associated with the imaging device, and the process further comprises:
re-orienting the first re-oriented frame along a vertical edge of the at least one re-oriented frame includes the first single subject that is closest to the central location of the conference room; and
re-orienting the second re-oriented frame along a vertical edge of the at least one re-oriented frame includes the second single subject that is closest to the central location of the conference room.

16. The apparatus of claim 15, wherein:
a third re-oriented frame of the at least one re-oriented frame includes a third single subject, and
the third single subject is located within the conference room, and the process further comprises:
re-orienting the third re-oriented frame along a vertical edge of the at least one re-oriented frame that is parallel to a vertical edge of the first re-oriented frame or a vertical edge of the second re-oriented frame.

17. The apparatus of claim 11, further comprising:
generating, by the processing device, a perspective corrected crop of a particular aspect ratio of the image as part of generating the at least one re-oriented frame.

18. The apparatus of claim 11, wherein:
the imaging device comprises a camera operating in a video conference environment, and
the image is captured from a video stream captured by the imaging device.

19. The apparatus of claim 11, further comprising:
performing the operation to re-orient the particular frame to correct a visual perspective of at least one of the plurality of subjects that is to be displayed by the display device.

20. A tangible, non-transitory, computer-readable medium storing program instructions that cause a device to execute a process comprising:
obtaining an image captured by an imaging device, the image including a plurality of subjects in a particular environment;
separating the image into a plurality of frames, wherein each frame of the plurality of frames includes one or more particular subjects among the plurality of subjects;
performing an operation to re-orient a particular frame of the plurality of frames to generate at least one re-oriented frame, wherein the at least one re-oriented frame is oriented along a particular vertical edge of the particular frame; and
providing the at least one re-oriented frame for display on a display device.
